(19) United States
(12) Patent Application Publication
(10) Pub. No.: US 2011/0219664 A1
(43) Pub. Date: Sep. 15, 2011

(54) Shoo Fly Sun Catcher

(76) Inventors: Shelly Casteel, Portland, OR (US); Kristin Casteel, Portland, OR (US)

(21) Appl. No.: 13/044,243

(22) Filed: Mar. 9, 2011

Related U.S. Application Data
(60) Provisional application No. 61/312,911, filed on Mar. 11, 2010.

(51) Int. Cl. A01M 29/28

(52) U.S. Cl. 43/107

(57) ABSTRACT

A decorative pest deterrent device that utilizes light refraction through a volume of liquid to repel nearby insects. A clear, elastic container is suspended from a decorative frame using one or a plurality of hooks. The container is filled with a liquid, preferably water, and refracts incoming light to confuse and ward off nearby pests. Liquid is fed into the container through an opening along its upper region, which is then closed by a set of tabs that mate together and attach to hooks for support. The device is a passive pest repellent and a decorative structure for a residential household, particularly in outdoor areas or entryways.

### CROSS REFERENCE TO RELATED APPLICATION

This application claims the benefit of U.S. Provisional Application No. 61/312,911 filed on Mar. 11, 2010, entitled “Shoo Fly Sun Catcher”

### BACKGROUND OF THE INVENTION

1. Field of the Invention

This invention relates broadly to household pest deterrents. More specifically, this invention relates to a decorative device that uses refracted light to ward off pests and insects.

2. Description of the Prior Art

The disclosed invention relates to a decorative, non-chemical device for repelling flies and other pests from an open area. The device discourages entry and repels pests using the prismatic effect of ambient light passing through a fluid within a transparent container. The device provides a passive means for repelling nearby pests, as well as an aesthetically pleasing structure for use in a residential household. The use of pesticides, sticky films or residue that are harmful to an environment are eliminated.

Prior to the instant invention, means of repelling flies and pests included chemical agents or physical barriers to prevent the intrusion of flies into an area. Fly swatters, flypaper, toxic chemicals and electronic devices have also been used with mixed success, mostly by killing those flies that had already entered the area. Chemical insect repellents may be used in an attempt to keep pests out of such areas. However, these chemicals, especially those containing DEET or pyrethrins, pose environmental and health hazards to humans, which can be particularly concerning in household areas. Chemical repellents are also more costly and require repeated application for sustained effectiveness. The disclosed invention requires no chemicals, no electricity or power supply, no human effort or vigilance, and can be used in a private or commercial location. It is particularly suited for household use, where décor and aesthetics are valued. The decorative nature of the device makes it particularly suitable for doorways and windows in homes where an attractive appearance is desired.

It is generally known that if one hangs a clear plastic bag filled with water in an area, pests avoid the area. However, this technique requires one to find and fill a clear plastic bag with water and somehow suspend the bag from an area, which can be difficult and tedious. In addition, plastic bags often become opaque over time and thus do not function as intended. Furthermore, generic plastic bags filled with water may rupture or tear easily, and are generally difficult to suspend without a measure of structural reinforcement.

Other non-chemical pest repellant devices have been devised, with limited success. U.S. Pat. No. 6,543,180 to Pace is directed toward a non-chemical device for repelling flies. The device includes a tear-shaped transparent envelope having a top portion, an interior pocket, and an opening providing access to the interior pocket. The opening is lined with a strip of mild insect repellant. The device also includes a clear transparent liquid within the interior pocket and a reinforced hanging hole along a top portion. The device repels flies from an area using the prismatic effect of ambient light passing through the fluid contents of the transparent container. However, this device lacks any aesthetic appeal that would promote residential household use.

U.S. Pat. No. 6,138,402 to Wotton is directed to a decorative insect trap for catching insects. The decorative trap includes a container having a mouth and an interior container, a cover defining a cover interior and a first opening through which the container is received into the cover interior. The cover takes the form of a fanciful character, including a face with a mouth opening that defines a path into the interior container. The trap also includes a funnel means positioned in the mouth for creating a substantially one-way passage for the insects to travel into the container.

U.S. Pat. No. 4,899,485 to Schneidmiller is directed to a containment-type trap for flying insects. The trap includes a rigid top member having a body portion that includes at least one entryway for insects. The insect trap also includes a flexible containment bag having a top orifice. The containment bag is suspended from and supported by the top member with the body portion of the top member projecting upwardly through the orifice of the bag. The bag carries containerized attractant material such as oil, water or both to create a viable trap for nearby insects.

U.S. Pat. No. 3,513,585 to Ross is directed to an insect trap having a bottom closure with an open top, a reflector mounting plate nesting therein and means for mounting an electrical system. The insect trap also includes a transparent top closure plate having a central raised embossment and overlapping peripheral flanges to effectively seal a juncture between the top edges of the bottom closure and the reflector plate, and a liquid container of transparent material nested over the embossment. The insect trap utilizes rays of light from a source shining through the body of liquid to trap flying insects.

U.S. Patent Publication No. 2007/0141945 to Chipman is directed to another device for repelling insects. The device includes a container having at least one rigid wall. The container includes an enclosed cavity which may be partially filled with a liquid. The wall and the liquid are capable of transmitting light whereby insects are repelled from an area in which the device is visible.

These prior art devices have several known drawbacks including a failure to focus on household use. The prior art devices focus on implementation in horse stalls or barns, or other outdoor areas where aesthetics are not a consideration. Additionally, the prior art requires one device for every 8 feet of area, whereas the present invention is larger and thus requires only one device for approximately 10 to 12 square feet. The small effective area in the prior art devices necessitates multiple unsightly containers within a given area. The increased size of the present invention allows for its placement in areas where multiple devices would be unsuitable or unsightly, such as along a household window or door frame. The prior art devices lack the consideration for incorporating a pleasing aesthetic appearance into an effective solution for deterring and repelling pests.

Further, the prior art discloses devices that either lack structural support for the fluid container or have a structural wall within the container portion. The present invention does not require the use of a structural wall within the container portion; rather the container is supported using an exterior structure, which provides the container with improved stability and effectiveness. The risk of ripping or tearing the container is decreased, encouraging the use of the present invention in a household location. The structural ring or shape may take the form of any eye-pleasing shape, including added decorative features to improve its aesthetics.

Additionally, unlike some of the prior art, the present invention is environmentally friendly. There are no required insect repellent strips or chemicals, which are particularly unsuitable for use in household areas such as kitchens and common areas.

Finally, those prior art devices that disclose containment traps are unsightly and require vigilance from the user for cleaning, discarding and replacing the containment structures. This activity is unsanitary and non-ideal for residential household use.

The present invention provides a means for repelling flying insects and pests that solves the drawbacks known in the prior art. Specifically, the disclosed invention provides a passive pest repellant that is ideal for household use, and one that requires minimal user effort to utilize. Common hazards and health risks associated with similar devices are also eliminated using the disclosed invention.

### SUMMARY OF THE INVENTION

In view of the foregoing disadvantages inherent in the known types of pest repellant devices now present in the prior art, the present invention provides a new pest repellant device wherein the same can be utilized for providing convenience for the user when repelling pests from a household area.

It is therefore an object of the present invention to provide a passive device for warding off insects from a given area that utilizes the prismatic effect of light through a liquid container.

Another object of the present invention is to provide a decorative pest deterrent device that is aesthetically pleasing, improving its utility within a residential household.

Yet another object of the present invention is to provide reliable pest deterrent that requires no human vigilance to maintain or set up, and contains no harmful substances as an active ingredient.

Yet another object of the present invention is to provide a stout, liquid-fillable container that requires no additional structural reinforcement to maintain a desired shape once filled with liquid, and one that is completely enclosed except for small fill holes along its upper region.

Other objects, features and advantages of the present invention will become apparent from the following detailed description taken in conjunction with the accompanying drawings.

### BRIEF DESCRIPTIONS OF THE DRAWINGS

FIG. 1 shows a perspective view of the circular embodiment of the pest deterrent device.

FIG. 2 shows an overhead view of the circular embodiment of the pest deterrent device, highlighting the container opening and tab securement means.

FIG. 3 shows a perspective view of the rectangular embodiment of the pest deterrent device.

### DETAILED DESCRIPTION OF THE INVENTION

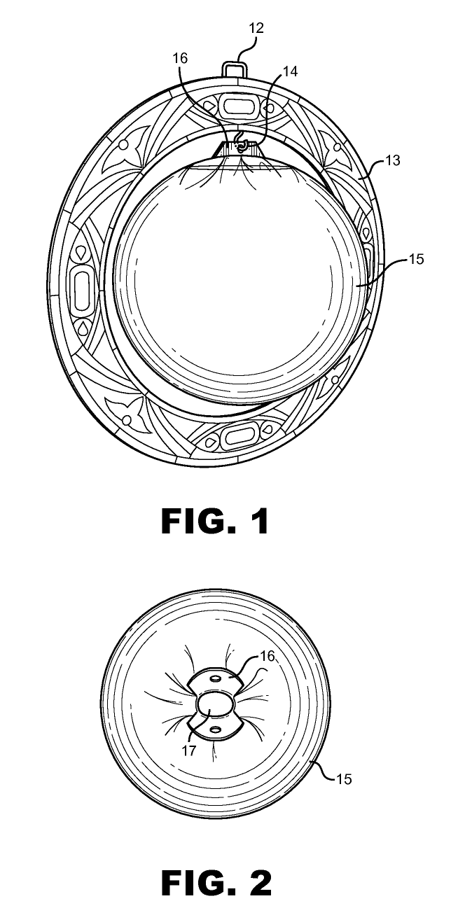

Referring now to FIG. 1, there is shown a perspective view of the circular embodiment of the pest deterrent device. A hollow, circular frame 13 is suspended from a structural support via a top-mounted bracket 12, and supports the weight of a spherical, water-filled container 15. The container 15 is interiorly mounted inside the circular frame 13. A pair of tabs 16 mates together along the top rim of the container 15 to close a fill hole, where water is received into the container 15. An interior hook 14 engages the mated tabs 16 through an eyelet to support the hanging mass of the container 15 and its contents.

Referring now to FIG. 2, there is shown an overhead view of the water-filled container 15. A pair of tabs 16 is spread apart to reveal a fluid infiltration hole 17, where water or other fluid is poured into the container 15 prior to hanging and utilizing the device.

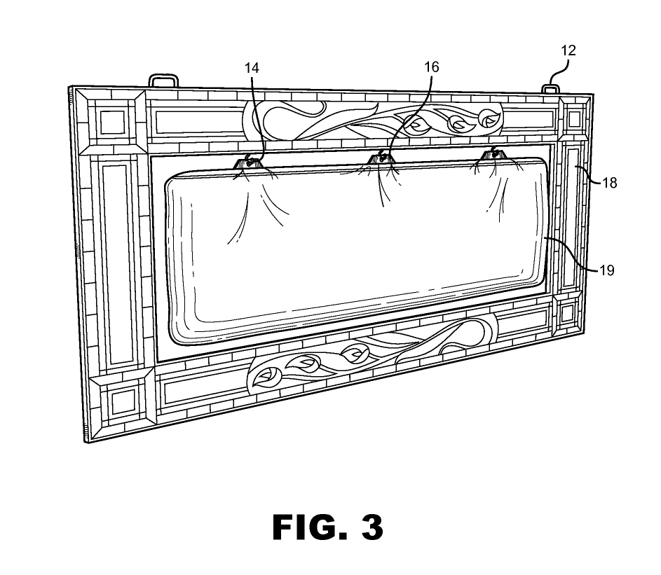

Referring now to FIG. 3, there is shown a perspective view of the rectangular embodiment of the pest deterrent device. A hollow, rectangular frame 18 is suspended from a structural support via a plurality of top-mounted brackets 12, and supports the weight of a rectangular, water-filled container 19. The container 19 is interiorly mounted inside the rectangular frame 18. A plurality tabs 16 along the top of the container 19 close fill holes and provide support points for a plurality of hooks 14 mounted inside the rectangular frame 18. The hooks 14 engage the tabs 16 through eyelets, securing the fill hole openings and supporting the hanging mass of the container 19 and its contents.

In use an individual fills the container with a volume of fluid, preferably water, and connects the tabs of the container to the interiorly mounted hooks along the frame of the device. The entire assembly is then suspended from a location with adequate structural reinforcement to support the weight of the device and the fluid, such as an open doorway or window frame. During operation, the device acts as a passive deterrent for nearby flying insects. The physics of refraction and the prismatic effect of light traveling through a fluid medium are capitalized on to disorient insects, which rely on visual cues to navigate and avoid predators. The fluid in the container alters the course and velocity of the incoming light, causing the light to bend, which disorients nearby flying insects. This phenomenon is known in the art to repel flying insects within a given area, resulting in a device that contains no harmful byproducts or active ingredients, and one that is low maintenance for the user.

The shape of the frame may take several different forms depending upon the user preference and considerations regarding its aesthetics within a residential household. The ornamental design of the frame may also vary, including different patterns and engravings. The frame may also take the form of a stained glass window with a structural frame support. The frame is intended to provide function in the form of a structural support for the fluid, but its form may take any decorative shape or pattern.

The water filled container is optically clear and mold resistant, ensuring clear transmission of light through itself for long periods of time. The structure of the container comprises a malleable, yet durable material such as a thermoplastic plastic or similar material. The container is completely sealed, except for small fill-holes along its upper region, which are closed when adjoining support tabs are mated and engaged with the support hooks of the frame. The tabs used to secure the container to the frame are of sufficient gauge and material to withstand the bearing forces associated with supporting the weight of the container and its fluid contents. The engagement with the interiorly mounted hooks may be reinforced with structural eyelets.

The container itself is critical to the operation and aesthetic nature of the device. The material of the container is of sufficient strength to maintain a desired shape when filled with an interior fluid, without the need for additional reinforcement such as an interior frame or support structure. In this way, the bag is completely translucent and of a unique shape to allow for a decorative container while permitting uninterrupted light transmission for deterring insects from entering a given area. The container is replaceable among the given assembly, and may be made of a recyclable compound for environmental concerns. This allows the container to be swapped out for different shapes, or for a newer bag that is replacing an aging counterpart.

The location of the device is dependent upon its intended use and user preference. The device may be used to deter pests from entering an area by mounting the device to the interior frame of a doorway. Alternatively, the device may be mounted to a structure in the middle of an open area to deter pests from a given area. The large size of the present invention scatters light over an extensive area and provides protection for a large area. The protected area is proportional to the size of the device, more specifically, to the length and width of the fluid container and the scatter of refracted light projected therefrom.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A device for repelling insects, comprising:
a support structure with a hollow central area;
a liquid filled container able to transmit light in such a manner as to repel insects;
a plurality of container attachment means within said support structure;
a series of tabs attached to said container capable of interlocking with said attachment means allowing said container to be suspended within said support structure.

2) A device, as in claim 1, wherein said support structure is decorative and suitable for home or household use.

3) A device as in claim 1, wherein said attachment means comprise a plurality of hooks.

4) A device as in claim 1, wherein said liquid filled container contains said liquid in a defined shape without internal support structure.

5) A device as in claim 4, wherein said defined shape is spherical.

6) A device as in claim 4, wherein said defined shape is an elongated rectangle with a defined thickness.

7) A device as in claim 1, wherein said liquid filled container is a replaceable structure.

8) A method of repelling insects, comprising the steps of:
attaching a liquid filled container to a decorative support structure;
placing said support structure and container in any location which may be attractive to pests;
and repelling pests from said location.

9) A method as in claim 8, wherein said location is a residential household.
